(19) United States
(12) Patent Application Publication
(10) Pub. No.: US 2003/0090031 A1
(43) Pub. Date: May 15, 2003

(54) Method and apparatus for producing polyimide molding

(76) Inventors: Hitoshi Nojiri, Shiga (JP); Masami Yanagida, Shiga (JP); Koji Sezaki, Shiga (JP); Teruo Matsutani, Shiga (JP)

Correspondence Address: Richard G. Lione, Brinks Hofer Gilson & Lione, P.O. Box 10395, Chicago, IL, 60610, US

(21) Appl. No.: 10/177,692

(22) Filed: Jun. 21, 2002

(30) Foreign Application Priority Data
Jun. 22, 2001 (JP) 2001-190378
Aug. 17, 2001 (JP) 2001-247607
Apr. 30, 2002 (JP) 2002-129154

(51) Int. Cl. B29C 39/38; C08J 5/00

(52) U.S. Cl. 264/234; 264/317; 264/331.19; 264/344; 425/256

(57) ABSTRACT

The present invention provides a method and an apparatus for producing a polyimide molding which have superior productivity and accuracy of dimension. The invention particularly relates to a tubular polyimide applicable to an electrophotographic device, such as a laser-beam printer and a copying machine, or a precision driving belt required for high strength and high dimensional stability.

The method of producing a polyimide molding according to the present invention comprises the steps of: mixing a solution containing polyamic acid as a main component and a chemical curing agent; providing a mixture to a mold while the mixture is still fluid; after the polyamic acid contained in the mixture is changed into a semi-formed body which develops self-supporting properties, taking out the semi-formed body from the mold, or inserting a mold for heating without taking out the semi-formed body, or removing a part of the mold; and drying solvents which are present on the surface of or inside the semi-formed body by heating the semi-formed body to produce a polyimide molding.

### RELATED APPLICATIONS

This application is related to, and claims priority from the following international applications: Japan Application Serial No. 2001-190378, filed Jun. 22, 2001; Japan Application Serial No. 2001-247607, filed Aug. 17, 2001; and Japan Application Serial No. 2002-129154, filed Apr. 30, 2002.

### BACKGROUND OF THE INVENTION

1. Field of the Invention

The present invention relates to a method and an apparatus for producing a polyimide molding by drying and imidizing a polyamic acid solution.

2. Description of Related Art

Polyimide resin has excellent heat resistance, dimensional resistance, mechanical strength, and chemical stability, and is used for a flexible printed wiring board, insulating material for a heat-resistant electric wire, hardwearing material, or the like. Further, a tubular polyimide molding is applicable to a precision driving belt, or a heat fusing belt or an intermediate transfer belt for an electrophotographic device such as a copying machine and laser-beam printer, for example.

Conventionally, a polyimide molding is produced by using one of various methods depending on its shape. When a film-like polyimide molding is produced, it can be produced as an endless film. In this case, a resinous solution is cast over an endless base material, and then heated and dried until it develops self-supporting properties. After that, the semi-cured film is peeled off from the base material. The film is conveyed to a furnace for heating at a high temperature with both ends thereof fixed with chucks or pins, and then rolled up as a polyimide film.

The aforementioned method is effective when a resultant polyimide molding is rolled up. However, when polyimide products are batch-produced, the aforementioned method raises various problems. Such problems will be described below while the batch production of polyimide products which are shaped like a tube or belt is taken as an example.

Conventionally, tube-like polyimide products (hereinafter referred to as “tubular polyimide”) are produced as follows. For example, a solution of polyimide precursor prepared by dispersing or dissolving polyamic acid in a solvent is applied to an outer surface of a surface-treated cylindrical mold or to an inner surface of a cylindrical mold. After adjusting its thickness, the mold is heated to vaporize the solvent or further heated after vaporization of the solvent. Thus the tubular polyimide is produced.

In the aforementioned method, a step with a problem to be addressed is a step of drying and curing the polyamic acid solution applied to the mold until it develops self-supporting properties. The polyamic acid solution is fluid at least until it develops self-supporting properties. For this reason, in order to retain the shape of the polyamic acid solution (resin) on the mold, it is necessary to rotate the mold, for example. Otherwise, when the mold is vertically placed, the polyamic acid solution runs downward. When such polyamide acid solution is dried and cured, a tubular polyimide having an uneven thickness is produced. Alternatively, when the mold is horizontally placed, the polyamic acid solution also runs downward, so that a tubular polyimide having an uneven thickness is produced. Even when a polyamic acid solution having a high viscosity is used, its viscosity is decreased because of heating. Therefore, the running of the solution cannot be prevented. Where the polyamic acid solution having a viscosity high enough not to run when it is heated, it is difficult to apply the solution on the mold.

This problem can be solved by rotating the mold, only when the mold is horizontally placed. However, the polyamic acid solution is dried and cured while the mold is being rotated as one of the steps in continuous mass-production process. Therefore, an apparatus for producing a polyimide molding becomes quite complicated because the mold must be heated in the furnace while being placed on a rotating stage. Further, since the apparatus must be repeatedly exposed to high and low temperatures, so that the lifetime of the apparatus is shortened, which is unfavorable in industrial production.

There are other methods to produce a tubular polyimide resin. Examples of these methods include an extrusion molding technique, injection molding technique, and a method of pouring liquid resin into a mold. These methods are generally used for molding thermoplastic resin. Therefore, they are not suitable for molding non-thermoplastic resin such as polyimide resin. Further, it is difficult to produce a thin polyimide molding with a thickness of several tens of micrometers by these methods, and there is a limit to the accuracy of dimension. Furthermore, a large-sized and expensive apparatus and instrument is required in these methods, which is a drawback of these methods.

The aforementioned problems also arise when the mold is not cylindrical in shape.

It is a known fact that a chemical curing agent is used for converting polyamic acid into polyimide, and the chemical curing agent has been already used for producing films. However, the chemical curing agent has not been used for forming a molding because there is high possibility that product defects are caused by curing reaction which proceeds at a constant speed at a room temperature during the forming process.

As the result of our researches to overcome the above disadvantages, we have eventually found a method of producing a polyimide molding which is a quite simple method from an industrial point of view.

### SUMMARY OF THE INVENTION

In order to achieve the aforementioned objects, an embodiment of a method of producing a polyimide molding according to the present invention comprises the steps of providing a solution containing a polyamic acid as a main component to a mold and drying the solution. Before providing the solution to the mold, a polyamic acid solution and a chemical curing agent are mixed, and then a mixture is provided to the mold.

Further, the method of the present invention can comprise the steps of: mixing a solution containing polyamic acid as a main component and a chemical curing agent; after the polyamic acid contained in a mixture is changed into a semi-formed body which develops self-supporting properties, taking out the semi-formed body from the mold or removing a part of the mold; and drying solvents which are present on the surface of or inside the semi-formed body by heating the semi-formed body to produce a polyimide molding.

As an apparatus that can realize the aforementioned method, disclosed is an apparatus for producing a polyimide molding comprising at least: a device for providing a solution containing polyamic acid as a main component; a device for providing a chemical curing agent; a mixer for continuously mixing the solution containing polyamic acid and the solution containing a chemical curing agent provided from the above respective devices; and a device connected to the mixer for applying a mixture to a tubular mold.

Further, another embodiment of the method of producing a polyimide molding according to the present invention is characterized in that: a solution containing polyamic acid as a main component and a chemical curing agent are mixed; a mixture is provided to a mold while it is still fluid; the polyamic acid is partially imidized by the chemical curing agent; after the mixture becomes non-fluid and develops self-supporting properties, a semi-cured body is fit over a mold for heating; after heating and drying, a polyimide molding is taken out from the mold.

An apparatus for producing a polyimide molding that can realize the aforementioned method comprises at least: a device for providing a solution containing polyamic acid as a main component; a device for providing a chemical curing agent; a mixing device for uniformly mixing the solution and the chemical curing agent; and a device for providing a mixture into a mold.

Another apparatus for producing a polyimide molding comprises at least: a device for providing a solution containing polyamic acid as a main component; a device for providing a chemical curing agent; a mixing device for uniformly mixing the solution and the chemical curing agent; and a device for providing a mixture into a mold pair which is composed of a movable inner and outer mold.

A still another embodiment of producing a polyimide molding according to the present invention is characterized by comprising at least the step of mixing the following solutions A and B:

Solution A: a solution that contains a dehydrating agent and that has polyamic acid as a main component; and

Solution B: a solution that contains a dehydrating catalyst and that has polyamic acid as a main component.

In this embodiment, a means for mixing the solutions A and B is preferably a static mixer. Liquid temperatures of the solutions A and B before mixing them are preferably 20° C. or less.

A further embodiment of the method according to the present invention can comprise the steps of: providing a mixture prepared by mixing the aforementioned solutions A and B into a mold; after the polyamic acid contained in the mixture is changed into a semi-formed body which develops self-supporting properties, taking out the semi-formed body from the mold or removing a part of the mold; and drying solvents which are present on the surface of or inside the semi-formed body by heating the semi-formed body to produce a polyimide molding.

Such method is suitably employed when a tubular polyimide molding is produced.

An apparatus that can realize the aforementioned method is characterized by comprising:

(1) service tank for the solution A;

(2) service tank for the solution B;

(3) device for quantitatively removing the solutions A and B from the respective service tanks; and

(4) mixing device for preparing a mixture by mixing the solutions A and B removed from the respective service tanks.

The aforementioned mixing device is preferably a static mixer.

In a still further embodiment, the apparatus for producing a polyimide molding according to the present invention further comprises: (5)a mold for containing the mixture and determining the shape of a resultant polyimide molding, in addition to (1) to (4) described above. The resultant polyimide molding can be shaped like a tube.

The aforementioned method for producing a polyimide molding according to the present invention can provide self-supporting properties to a polyamic acid fluid coating in a short time, so that productivity can be increased. Further, since a semi-cured tubular body can be easily taken out from the mold, a polyimide molding of the present invention can be easily produced. Furthermore, there is a low possibility that product defects are caused, so that the production yield can be improved.

Further, in this method comprising the step of developing self-supporting properties in the mold, the thickness of the tubular body can be accurately determined and the determined thickness is not changed later, unlike in a conventional method. Furthermore, since the mixture develops its self-supporting properties in a short time by the effect of the chemical curing agent and the semi-formed body can be more easily taken out from the mold, a polyimide molding can be produced quite easily. By pouring the mixture into a number of molds one after another, semicontinuous production of the polyimide molding and high productivity can be achieved. Further, the aforementioned workability is hard to cause product defects. The mixture is semi-cured in a closed space, so that product defects caused by dust can be reduced and the production yield can be thus improved.

### BRIEF DESCRIPTION OF THE DRAWINGS

FIG. 1-1 shows that a sufficient amount of a mixture 2 is applied to the inner surface of an outer mold 1, and FIG. 1-2 shows that an inner mold is inserted and the mixture is filled in a tubular space between the inner and outer molds.

FIG. 2-1 shows that the outer mold contains the mixture, and FIG. 2-2 shows that the inner mold is inserted and the mixture is filled in a tubular space between the inner and outer molds.

FIG. 3 shows a process of inserting a mold for heating while the inner mold being removed.

FIG. 4 shows a process of inserting a mold with holes for releasing the air when a cylindrical inner mold does not have sufficient strength.

### DESCRIPTION OF THE PREFERRED EMBODIMENTS

A “polyimide molding” used herein includes moldings of various shapes such as symmetrical tubular molding and asymmetrical tubular molding composed mainly of polyimide.

A method of producing a polyimide molding according to the present invention basically comprises the step of reacting a chemical curing agent in a solution containing polyamic acid as a main component so as to invert the whole or a part of polyamic acid into polyimide.

The solution to be used for producing a polyimide molding according to the present invention that has polyamic acid as a main component is prepared by polymerization of a tetracarboxylic acid anhydride component and a diamine component in an organic polar solvent, for example.

Any tetracarboxylic acid components can be used in the present invention. Examples of tetracarboxylic acid anhydride components include: aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic acid dianhydride, 1,2,3,4-cyclopentanetetracarboxylic dianhydride, 2,3,5-tricarboxycyclopentyl acetic dianhydride, 3,5,6-tricarboxy norbornan-2-acetic dianhydride, 2,3,4,5-tetrahydrofran tetracarboxylic dianhydride, 5-(2,5-dioxotetrahydrofural)-3-methyl-3-cyclohexene-1,2-dicarboxylic dianhydride, and bicyclo[2,2,2]-oct-7-ene-2,3,5,6-tetracarboxylic dianhydride; aromatic tetracarboxylic dianhydrides such as pyromelletic dianhydride, 3,3′,4,4′-benzophenone tetracarboxylic dianhydride, 3,3′,4,4′-biphenylsulfone tetracarboxylic dianhydride, 1,4,5,8-naphthalenetetracarboxylic dianhydride, 2,3,6,7-naphthalenetetracarboxylic acid, 3,3′,4,4′-biphenylether tetracarboxylic dianhydride, 3,3′,4,4′-dimethyidiphenylsilane tetracarboxylic dianhydride, 3,3′,4,4′- tetraphenylsilane tetracarboxylic dianhydride, 1,2,3,4-furantetracarboxylic dianhydride, 4,4′-bis(3,4-dicarboxyphenoxy)diphenylsulfide dianhydride, 4,4′bis(3,4-dicarboxyphenoxy)diphenylsulfonic acid dianhydride, 4,4′-bis(3,4-dicarboxyphenoxy)diphenylpropane dianhydride, 3,3′,4,4′- perfluoro isopropylidene diphthalic dianhydride, 3,3′,4,4′- biphenyltetracarboxylic dianhydride, bis(phthalic acid)phenylphosphine oxide dianhydride, p-phenylene-bis(triphenylphthalic acid)dianhydride, m-phenylene-bis(triphenylphthalic acid)dianhydride, bis(triphenylphthalic acid)-4,4′- diphenyl ether dianhydride, and bis(triphenylphthalic acid )-4,4′-diphenylmethane dianhydride; and aliphatic tetracarboxylic dianhydrides containing aromatic ring such as 1,3,3a,4,5,9b-(hexahydro-2,5-dioxo-3-furanyl)-naphth[1,2c]furan-1,3-dione, 1,3,3a,4,5,9b-hexahydro-5-methyl-5-(tetrahydro-2,5-dioxo-3-furanyl)-naphth[1,2-c]furan-1,3-dione, and 1,3,3a,4,5,9b-hexahydro-8-methyl-5-(tetrahydro-2,5-dioxo-3-furanyl)-naphth[1,2-c]furan-1,3-dione. These tetracarboxylic dianhydrides can be used alone or in combination.

Any diamines can be used in the present invention. Examples of diamines include: aromatic diamines such as p-phenylene diamine, m-phenylene diamine, 4,4′-diaminodiphenylmethane, 4,4′-diaminodiphenylethane, 4,4′-diaminodiphenyl ether, 4,4′- diaminodiphenyl sulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′aminophenyl)-1,3,3-trimethylindane, 4,4′-diaminobenzanilide, 3,5-diamino-3′-trifluoromethylbenzanilide, 3,5-diamino-4′-trifluoromethylbenzanilide,3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenylene isopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines containing two amino groups bonded to aromatic ring and hetero atom other than nitrogen atom of the amino group such as diaminotetoraphenyl thiophene; and aliphatic diamines and alicyclic diamines such as 1,1-metaxylylenediamine, 1,3-propanediamine, tetramethylene diamine, pentamethylene diamine, octamethylene diamine, nonamethylene diamine, 4,4-diaminoheptamethylene diamine, 1,4-diaminocyclohexane, isoforon diamine, tetrahydrodicyclopentadienylene diamine, hexahydro-4,7-methanoindanylene dimethylene diamine, tricyclo[6,2,1,0^{2.7}]-undecylene dimethyl diamine, and 4,4′-methylenebis(cyclohexylamine).

These diamines can be used alone or in combination. Although preferable diamine is aromatic diamine, any diamines can be used.

Examples of organic polar solvents to be used for the reaction with polyamic acid include: sulfoxide solvents such as dimethyl sulfoxide and diethyl sulfoxide; formamide solvents such as N,N-dimethylformamide and N,N-diethylformamide; acetamide solvents such as N,N-dimethylacetamide and N,N-diethylacetamide; pyrrolidone solvents such as N-methyl-2-pyrrolidone and N-vinyl-2-pyrrolidone; phenol solvents such as phenol, o-cresol, m-cresol, p-cresol, xylenol, phenol halide, and catechol; ether solvents such as tetrahydrofuran, dioxane, and dioxolane; alcohols such as methanol, ethanol, and butanol; cellosolve solvents such as butylcellosolve; hexamethylphosphoramide; and γ-butyrolactone. Preferably, these organic polar solvents are used alone or in combination. However, aromatic hydrocarbons such as xylene and toluene can also be used. Any solvents which dissolves the polyamic acid can be used.

In the method of the present invention, various additives can be added to a polyamic acid solution so as to control resistivity, strength, ultraviolet light resistance, humidity resistance of a resultant polyimide molding.

For example, when a tubular polyimide is used as a transfer belt or an intermediate transfer belt for an electrophotographic device, it is quite important that the volume resistivity of the polyimide is in a range of 1×10⁶ to 10¹⁵Ω·cm, preferably 1×10⁷ to 10¹³Ω·cm. In order to ensure the above range of volume resistivity, the most effective method is to mix a proper amount of conductive inorganic powders such as carbon black powders in resin, which is a common method to make insulating resin conductive, to reduce resistivity, or to prevent static electricity. The same effects can be produced using small diameter metal granules; metal oxide granules; titanium oxide, various inorganic granules, or whiskers coated with conductive material. Further, an ionic conductive material such as LiCl can be added.

The tubular polyimide can be used as a toner fusing belt for an electrophotographic device. In this case, if heat conductive inorganic granules are introduced into tubular polyimide resin, heat fusing properties of the tubular polyimide can be improved. Any heat conductive inorganic granules can be used, as far as they conduct heat. Examples of heat conductive inorganic granules include: aluminum nitride, boron nitride, alumina, silicon carbide, silicon, silica, and graphite. Among them, boron nitride is preferable, because it has high heat conductivity, exhibits high mold releasing effect, and is chemically stable and harmless. When the tubular polyimide is used as a driving belt for transmission of force, various additives such as short fiber glass, which are generally used for improving strength, can be added to improve the strength of the belt.

The aforementioned inorganic granules can be used alone or in combination, depending on the use of the polyimide molding. Although the amount of additives to be added depends on kinds and effects of the additives, it is general to add about 1 to 150 wt % of additives with respect to polyimide solid contents. If 150 wt % or more of additives are added, the strength of the polyimide is possibly reduced, depending on kinds of additives. On the contrary, if 1 wt % or less of additives are added, sufficient effects cannot be produced to improve general physical characteristics such as heat conductivity and strength. However, in the case of ionic conductive compound such as LiCl, electric resistance can be reduced by adding a tiny amount thereof.

It is preferable that the aforementioned organic solvent solution contains 5 to 25 wt % of polyamic acid as a main component. However, polyamic acid content is not limited to the above range. Even if polyamic acid content exceeds the above range, the polyimide molding can be produced in good condition in some cases, depending on the amount of additives to be added. A preferable viscosity of the solution is in a range of 1 to 1000 Pa·sec.

Before the solution is formed into a desired shape, a chemical curing agent is mixed in the aforementioned solution. In this specification, the term “chemical curing agent” indicates an agent that produces a chemical effect of converting polyamic acid into polyimide by ring closure and contains dehydrating agent and dehydrating catalyst without any paticular heating.

As a dehydrating agent, acid anhydride compound can be used. Although any acid anhydride can be used, as far as it has a dehydrating ability, the most preferable acid anhydride is acetic anhydride in terms of its reactivity. Another reason that acetic anhydride is suitably used is that reaction products are quickly removed from the reaction system at a relatively low temperature after reaction.

The most suitable dehydrating catalyst is a tertiary amine compound. Examples of tertiary amines include: quinolines such as isoquinoline; picolines such as β-picoline; and aliphatic tertiary amines such as trimethylamine. Particularly preferable tertiary amines which have appropriate reactivity and improve mechanical strength of a resultant tubular polyimide are isoquinoline and β-picoline.

The method for producing a polyimide molding according to the present invention comprises the steps of: preparing a solution containing polyamic acid as a main component; providing the solution to a mold; and drying the solution. In the step of preparing the solution, an polyamic acid solution and a chemical curing agent are mixed.

A chemical curing agent is mixed to a polyamic acid solution in one of the following two ways:

(1) to mix a solution of a chemical curing agent with a polyamic acid solution; and

(2) to mix a polyamic acid solution and a dehydrating catalyst with a polyamic acid solution and a dehydrating agent.

When an active ingredient contained in the chemical curing agent is a poor solvent of polyamic acid polymer, it is preferable to prepare a chemical curing agent solution by adding a solvent that can dissolve the polyamic acid to the aforementioned acid anhydride and/or tertiary amine. For example, acetic anhydride is a poor solvent of most polyamic acids, so that it takes time to uniformly mix a solution containing acetic anhydride as a main component with polyamic acid. Further, during this mixing step, polyamic acid is not dissolved sufficiently in some parts of the solution. Therefore, there is a fear of the generation of undissolved gel in these parts, the inhomogenation of the inorganic matter, and the defect formation of the polyimide molding.

As a solvent that can dissolve polyamic acid, the same solvents as described above as polymer solvents of polyamic acid can be used. It is particularly preferable that the same solvent that is used for polymerization of polyamic acid is used. The amount of solvent to be used is about 10 to 50 wt % of a chemical curing agent. However, the amount of solvent to be used is not particularly limited. It varies depending on the composition of the polyamic acid and the composition of the solvent for dissolving the polyamic acid. The solvent does not always needed, if the mixer has a high mixing power.

The time between when the chemical curing agent is mixed with the polyamic acid solution and when the polyamic acid develops self-supporting properties can be controlled in accordance with the concentration of the chemical curing agent. In order to shorten this time, a metal salt can be added to the polyamic acid solution. Examples of metal salts include metal chlorides, metal iodides, metal nitrates and the like. Specific examples thereof are SnCl₂, Aul₃, and AgNO₃.

It is preferable that the water contents of the polyamic acid solution and the chemical curing agent are controlled to as low contents as possible. The water opens acid anhydride ring contained in the chemical curing agent and thus prevents fast chemical curing. As the result, it takes longer time between when the chemical curing is mixed with the polyamic acid solution and when the polyamic acid develops self-supporting properties. Further, the water contributes to the decomposition of polyamic acid polymer. Therefore, it is preferable that the water content in the polyamic acid solution is as low as possible. Specifically, preferable water content is 0.5 wt % or less, and more preferable water content is 500 ppm or less. In order to reduce the water content, the solvent to be used can be dehydrated beforehand, or the solution can be prepared in the dry area or in the flow of an inert gas.

The polyamic acid solution and the chemical curing agent are mixed in one of the following two ways:

(1) to mix a solution of chemical curing agent with a polyamic acid solution; and

(2) to mix a polyamic acid solution and a dehydrating catalyst with a polyamic acid solution and a dehydrating agent.

Specifically, the polyamic acid solution and the chemical curing agent are uniformly and continuously mixed in a mixer by pouring the polyamic acid solution and the chemical curing agent into the mixer from different lines.

In one embodiment of a method of producing a polyimide molding according to the present invention, a desired polyimide molding can be produced by the following process steps.

The method of producing a polyimide molding according to the present invention comprises the steps of: mixing a solution containing polyamic acid as a main component and a chemical curing agent; providing a mixture to a mold while the mixture is still fluid; after the polyamic acid contained in the mixture is changed into a semi-formed body which develops self-supporting properties, taking out the semi-formed body from the mold, or inserting a mold for heating without taking out the semi-formed body, or removing a part of the mold; and drying solvents which are present on the surface of or inside the semi-formed body by heating the semi-formed body to produce a polyimide molding.

The term “semi-formed body” used herein means a non-fluid body (self-supporting body) in which polyamic acid is incompletely imidized and/or a non-fluid body in which solvents of the polyamic acid is incompletely dried.

There are still many solvents contained in such semi-formed body or attached on the surface thereof. In order to dry these solvents, the semi-formed body is taken out from the mold or a part of the mold is removed from the semi-formed body to make the solvent residue in a condition to volatilize or dry. In this case, one of the important things is to conduct a series of process steps in succession while paying attention to avoid air bubbles coming into the solution. When the polyamic acid and the chemical curing agent are put into a different container and mixed with stirring, the air is trapped in the mixture. Therefore, it is necessary to remove the air bubbles from the mixture after the mixing step. If the air bubbles are spontaneously removed by leaving the mixture to stand, the mixture is cured too much. As the result, it is impossible to mold it in the later step. If the air bubbles are removed by a centrifugal separator, the removing time can be shortened. However, the centrifugal separator cannot be used in the system with fillers added since the fillers added in the mixture are concentrated to one side by centrifugal force, and thus the use is limited.

It is preferable that the air bubbles are removed from the polyamic acid and the chemical curing agent under a vacuum condition before they are mixed.

An apparatus for producing a polyimide molding according to one embodiment of the present invention comprises at least: a device for providing a solution containing polyamic acid as a main component; a device for providing a chemical curing agent; a mixer for continuously mixing the solution provided from the device for providing a solution containing polyamic acid and the chemical curing agent provided from the device for providing a chemical curing agent; and a device for applying a mixture to a tubular mold, wherein the device for applying a mixture is connected to the mixer.

In order to uniformly and quickly mix the polyamic acid solution and the chemical curing agent, various types of mixers can be used in various ways.

For example, it is preferable for prevention of poor mixing that the mixer has a plurality of mixing blades along the flow of the solution. An inlet for supplying the chemical curing agent is generally provided on the upper stage (upstream stage) of the mixing blades. However, in order to increase a mixing efficiency, a line for chemical cuing agent can be provided on the mixing axis and in the mixing blades, and one or more inlets can be provided to the tip of the blade or on the middle of the blade.

The mixing efficiency increases with the number of rotations of the mixing blades of the mixer. However, too higher efficiency produces remarkable mixing heat, and thus the imidization is caused during the mixing step. For this reason, it is preferable that the mixer is equipped with a cooling device and that the number of rotations may be limited to prevent too much increase in the temperature of the solution in accordance with cooling power of the cooling device. Where the mixture of the polyamic acid solution and the chemical curing agent is provided from the mixer to the mold, cooling is an effective way to prevent the curing of polyamic acid in the mixer or in the line before the solution reaches to the mold.

However, where the resinous solution remaining in the line is still likely to cause the local curing, another effective way is that a mixture of a cold setting inhibitor and a solution containing a chemical curing agent or polyamic acid as a main component is pored into a cylindrical mold and then heated for imidization so as to make the mixture non-fluid. An example of such cold setting inhibitor is acetyl acetone.

The mixture is then subjected to a molding step using continuous molds. For example, the mixture of a polyamic acid solution and a chemical curing agent is applied evenly to an outer or inner surface of a cylindrical mold.

In the aforementioned case, the polyamic acid solution has generally a high viscosity, while the chemical curing agent has a low viscosity. Therefore, it is necessary to mix the mixture using a mixer with rotating blades at high speed.

In order to solve the above problem, the following alternative method of mixing the polyamic acid solution and the chemical curing agent is preferable. Solutions A and B described below are prepared separately and then mixed to produce a polyamic acid solution containing a dehydrating agent or dehydrating catalyst.

Solution A: a solution that contains a dehydrating agent and that has polyamic acid as a main component

Solution B: a solution that contains a dehydrating catalyst and that has polyamic acid as a main component.

A further embodiment of the method of producing a polyimide molding according to the present invention can comprise the steps of: mixing the solutions A and B; pouring a mixture into a mold; after polyamic acid contained in the mixture is changed into a semi-formed body which develops self-supporting properties, taking out the semi-formed body from the mold or removing a part of the mold; and drying solvents which are present on the surface of or inside the semi-formed body by heating the semi-formed body to produce a polyimide molding.

This is a unique method making a use of characteristic that the curing abilities of the dehydrating agent and dehydrating catalyst are not exhibited under a non-heating condition (at a temperature of 20° C. or less) when only either one of them is contained in the solution but their curing abilities to initiate curing reaction of polyamic acid are exhibited when they coexist in the same solution.

It is suitable that liquid temperatures of the solutions A and B are 20° C. or less before mixing.

In this method, there comes out no big difference in viscosity between the solutions A and B, so that the solutions A and B can be uniformly mixed under a mild condition. Also, the method of the present invention is suitably used in the batch-production, because required amounts of solutions A and B can be mixed by the method of the present invention.

For example, the solutions A and B can be mixed using a static mixer. The mixing by a static mixer is more preferable in terms of that it is effective to prevent the generation of mixing heat, to prevent the cleavage of a resin molecule chain due to mixing, and to prevent the breakdown of inorganic filler if the inorganic filler is added to resin.

A polyamic acid solution, dehydrating agent, and dehydrating catalyst are mixed using a static mixer in one of the following four ways:

First case: A polyamic acid resinous solution is used as one solution, and a solution containing at least a dehydrating agent and a dehydrating catalyst as the other solution;

Second case: A solution containing polyamic acid resin and a dehydrating agent is used as one solution, and a solution containing a dehydrating catalyst as the other solution;

Third case: A solution containing polyamic acid resin and a dehydrating catalyst is used as one solution, and a solution containing a dehydrating agent as the other solution; and

Fourth case: A solution containing polyamic acid resin and a dehydrating agent is used as one solution, and a solution containing a polyamic acid resin and a dehydrating catalyst as the other solution.

Among them, the fourth case is preferable, because the two solutions used in this case have a viscosity close to each other, so that they can be mixed easily by a static mixer.

An apparatus for producing a polyimide molding composing the following devices (1) to (4) is taken as an example of a producing device that can realize the aforementioned producing method:

(1) a service tank for the solution A;

(2) a service tank for the solution B;

(3) a device for quantitatively removing the solutions A and B from the respective service tanks; and

(4) a mixing device for preparing a mixture by mixing the solutions A and B removed from the respective service tanks.

In the present invention, two types of organic solvent solutions (solutions A and B) containing polyamic acid as a main component are prepared. One of the solutions contains an dehydrating agent, and the other contains a dehydrating catalyst. By mixing the solutions A and B, curing reaction is started.

In this case, it is important to conduct a series of process steps in succession while paying attention to avoid air bubbles coming into the solution. Therefore, it is preferable that the service tanks (1) and (2), the device (3), and the mixing device (4) are connected by a series of pipes as one apparatus so as to prevent the product defects from being caused by the air bubbles.

Further, the service tanks (1) and (2) and pipes are preferably equipped with a cooling device so as to prevent the liquid temperatures of the solutions A and B from exceeding 20° C. Furthermore, it is also preferable that the mixing device (4) is equipped with a cooling device.

As stated above, the mixing device is preferably a static mixer.

Additionally, a gear pump is favorably used as an apparatus for quantitatively removing each solution mentioned in (3) because the pump can provide the mixer with a polyamic acid solution with high viscosity by accurately discharging the solution from the service tank.

To provide a polyamic acid solution, wherein a dehydrating agent and a dehydrating catalyst are mixed, inside a mold from the mixer, cooling is effective to slow down a progress of reaction as a method for preventing curing of polyamic acid inside piping before reaching inside the mold as well as inside the mixer.

When there is a fear that curing proceeds unevenly because of the residence of a resin solution in line and the like, a method for non-fluidizing by mixing a cold setting inhibitor in any one of the solutions and partial imidization caused by heating after pouring the mixture into the mold may be used. Examples of cold setting inhibitors may include acetylacetone.

The time for polyamic acid to have self-supporting properties after the mixture of a chemical curing agent component (dehydrator and dehydrating catalyst) and the polyamic acid solution can be controlled by the concentration of the chemical curing agent.

A method for adding the above-mentioned metallic salt to the polyamic acid solution may be carried out as means for further shortening the time. Metallic chloride, metallic iodide, and metallic nitride and the like are applicable to a metallic salt, and more particularly, SnCl₂, Aul₃, and AgNO₃ and the like may be used.

It is preferable to control the water content of the polyamic acid solution, dehydrator, and dehydrating catalyst as little as possible as mentioned above, and its method is in the same manner as in the above-mentioned.

A series of processes of measuring two reactive components and mixing these components with a static mixer and the like to pour into a mold are known as a technique called “LIM” (Liquid injection molding) or “RIM” (Reaction injection molding). The present invention is, however, quite different from conventional techniques because the present invention is not a simple application of an RIM but overcomes special problems with polyimide molding. An explanation will be now given in detail.

In a conventional RIM (or LIM), a reaction product is produced by direct reaction between a plurality of components mixed before molding, but in the present invention, both solutions A and B contain common polyamic acid as a resin composition, so that a mechanism of curing for allowing conversion reaction from polyamic acid to polyimide even without heating at high temperatures by the mixture of the dehydrator in solution A and the dehydrating catalyst in solution B instead of directly producing a reaction product by the components contained in solutions A and B.

A solventless-type reaction component system is used in the conventional RIM (or LIM) and a cured material in the mold becomes a molding as it is. Even if a mold lubricant is used on the mold surface, a quite great strength is applied to disengage the cured material because an operation to compulsively extract a cured lump from the mold is needed when taking the cured material out.

Accordingly, rod-like bodies exceed an established diameter and the like are useful, but film-like bodies such as tubes and belts have problems that a product itself causes deformation at the time of disengagememnt, which results in being unsuitable to a method for producing a polyimide tublar molding.

The present invention is a unique technique to realize an easy removal from a mold by taking advantage of the soaking excess over permissible solvent content out of the cured resin surface because the permissible limits of solvent content becomes smaller as the polyamic acid solution is converted to polyimide and this soaked solution is used as a kind of lubricant.

In addition to the above-mentioned structure, the method for producing a polyimide molding according to the present invention has a process of providing a mold for regulating the shape of a molding with the above-mentioned mixture.

A polyimide molding in the present invention includes various shapes of moldings including symmetrical tubes and asymmetrical tubes essentially consisting of polyimide, preferable embodiments of the present invention will be described in detail using tubular bodies particularly effective and having a wide range of industrial applications (belts or tubes).

According to the method and the apparatus for producing a polyimide molding of this invention, a tubular polyimide molding body, which means a seamless and hollow-state film essentially consisting of polyimide, can be molded regardless of how big is the diameter or how thick is the thickness. Thus, the method and apparatus for producing a polyimide molding are applicable to polyimide molding often called belts with a big diameter as well as to polyimide molding often called tubes with a small diameter.

An explanation will now be given to a concrete method for working a polyimide precursor solution essentially consisting of polyamic acid wherein a chemical curing agent component is mixed, taking an example of molding a tubular polyimide.

In the case of coating, the above-mentioned solution is adhered by the thickness of the inner surface or the outer surface of the tubular coating mold or the thickness of the outer surface of the cylindrical mold, but various kinds of means for adhesion may be used.

For example, the inner part of the tubular mold is moved while extruding this solution from a cylindrical die to be adhered to the inner surface of the mold. At this time, the mold may be rotated so that the precision of the thickness can be improved. For another method, a solvent film is formed with a thickness which is thicker than a targeted thickness on the inner surface of the tubular mold or the outer surface of the tubular mold or the cylindrical mold.

The formation means may use the above-mentioned die or a method, such as dip coating. After that, an excess solution is removed by a relative move of jigs with predetermined clearance to a mold. Additionally, various kinds of means for molding a tubular body may be applicable.

The thickness of a polyimide precursor solution is not particularly limited, but the thickness of the tubular body after drying and imidization is preferably 10 to 1,000 μm, particularly preferable 30 to 150 μm. If the thickness is too thick, it will take a considerable time to vaporize a solvent in the heating and drying process. This may cause deterioration of strength due to simultaneous proceeding of cutting a molecular chain by heating. If the thickness is too thin, handling will be difficult after drying although there are no problems by the stages of heating, which results in being inadequate to work into a tube state by such a method.

It is preferable that the thickness of the polyimide precursor solution specified once has a minimum change after the formation of a coated film until self-supporting properties of the coated film developed. Considering the temperature of the resin, mold and atmosphere when coating or after coating from this point, the present invention is found to be feasible in a wide range of temperatures. More particularly, fluidity in the resin solution is in a relatively depressed at a low temperature, e.g., 0° C. and imidization proceeds in chemical curing even at low temperatures. Despite an increase in fluidity of the resin solution when the temperature is at a high temperature, e.g., 50° C., the duration that the resin solution has fluidity becomes shorter because of acceleration of imidization rate in responsive to that temperature. Therefore, the degree of fluidity of the resin solution itself does not become so large. Thus, this invention has an advantage of not being affected by the temperature of the resin solution, mold, and atmosphere. However, the temperature is preferably −20° C. to 120° C., more preferably 0° C. to 80° C. from the viewpoints of easiness and safety of the operation and the like.

Upon obtaining self-supporting properties of the coated film, the tubular semi-cured material is taken out from the mold. Conventionally, a process of removing the coated film from the mold has difficulties in the case of a process of coating a solution and drying due to strong adhesion between the dried resin and mold, but in the present invention, the presence of a solvent between the resin and mold acting as a lubricant makes it easier to take out both outer coating and inner coating while obtaining self-supporting properties on the resin by chemical curing.

It is preferable for the removed tubular semi-cured material to be separately fit over the inner mold (mold for heating) and then heated so that it is adjusted its internal diameter while final curing and heating.

Imidization is completed by heating this mold with whole resin tubular body. A mold lubricant may be used for the mold for the purpose of securing mold releasing property of the tubular body after imidization. As compared with application of a mold lubricant to the coating mold, the application of a mold lubricant to the mold for heating supporting the tubular body in which curing has as proceeded as self-supporting properties once developed has no soaking of the mold lubricant into the inner part of the resin and is affected relatively a little. If the mold lubricant is adhered only to the surface of the mold, it will be also easily removed later. Similarly, a porous medium having a perforated air holes may be used as a mold to make the removal of the completed tubular body easy. An air layer is formed between the tubular body and mold by discharging air from the inside to the outside the porous medium, which enables an easy removal of the tubular body by sliding the body. Porous ceramics, porous metals, and porous carbons may be used as porous media. Porous media are not only obtained as continuous bodies, such as sintered bodies but also obtained by a method for boring finer holes in a plate-like metal by punching and drilling and welding it in a cylindrical shape. When the strength is insufficient with a cylindrical mold made by working the plate-like metal, it is also possible to take up a method for fitting a mold in which holes for air discharge are bored in further rough state into its further inside (See FIG. 1). For another means for making the removal easier, a method for removing a tubular polyimide by fitting the semi-cured resin tubular body outside the removable and attachable combined mold which comprises a heat resistant cylindrical mold (core body) and a heat resistant tubular body made from a thin metal fit over the outer periphery of the tubular body and heating the whole mold, and removing a peripheral tube of the combined mold together with the tubular polyimide after heating and cooling, and then removing the tubular polyimide by deforming the peripheral tube may be adopted.

As mentioned above, the method for fitting the outside of the mold for heating by taking out a semi-formed tubular body from the coating mold and heating the tubular body has been described so far, but there is another method for heating the coating mold without removing the tubular body from the coating mold. The method for heating the whole coating mold, however, tends to have higher adhesion strength to the mold for heating, compared with the method for heating the tubular body after fitting the outside of the other mold by the removal of the tubular body from the coating mold. Some soaking of a release agent into resin is caused by the use of the release agent in the coating mold, so that problems, such as the deterioration of strength might be raised. As compared with a conventional method for curing only by heating, however, its adhesion strength is much lower because a thin layer of the exudates is formed between the coating mold and resin in the semi-curing stage. This enables the coating mold to be used as a mold for heating as it is.

There is also a method for without complexity in separately preparing the coating mold and mold for heating to be transferred. That is, the length of the coating mold that is twice as long as a desired length of the tubular body is previously prepared to perform operation by the process of coating and semi-curing using a half of the mold, sliding the semi-cured tubular body to a release coated remaining half portion, and then heating as it is. In this case, although there are industrial disadvantages because the mold is bigger and a large heating furnace is needed, its processes are simplified.

Additionally, in the method for producing a polyimide molding of the present invention, a process of providing a mold for regulating the shape of the molding with the above-mentioned mixture may include a process of pouring a mixture essentially consisting of polyamic acid into a mold wherein cavities are formed.

More specifically, a mixture obtained by the mixture of at least polyamic acid, an organic solvent, a dehydrator, and a dehydrating catalyst is poured into the tubular cavities of the mold while its fluidity is maintained when a tubular body is formed. On conversion of polyamic acid to a self-supporting properties semi-formed tubular body due to a loss of fluidity caused by the effect of a chemical curing agent, the semi-formed tubular body is taken out from the mold to dry the solvent and the tubular body is fit over the mold for heating, and then imidization proceeds by heating and drying the solvent.

It is possible to dry the semi-formed tubular body only by removing the outer mold when the mold is a cylindrical mold pair composed of a movable inner and outer mold, so that there is no need to take out the semi-formed tubular body from the mold. To dry off the solvent and imidized, the semi-formed tubular body may be heated on the inner mold from which the outer mold has been removed.

A process of providing the cylindrical mold pair composed of an inner and outer mold which is movable with a polyamic acid solution and a process of forming a tubular body after the process will now be described in detail. A polyamic acid solution (mixture) after the mixture of a dehydrator and a dehydrating catalyst is provided in a cylindrical mold to fill the mold. This process is performed broadly by two kinds of methods.

The first method is to pour a mixture into a tubular space wherein an outer mold and an inner mold are previously set to form the space.

The second method is a method wherein an outer mold and an inner mold are movable each other, which are apart in the stage of providing a mixture, and after providing a resin to any mold, the mixture is filled in a tubular space formed as a result of a move of either or both of the molds.

Now, an explanation will be given to each of the methods.

In the case of the first method, it is especially important to fill the mixture lest the provided mixture should catch air. The following resources may be, therefore, performed. To provide the mixture inside the cylindrical mold, a supply port may be formed into a cylindrical shape so that resin may be uniformly filled over the whole circumference. It is also important to improve the accuracy of dimension of each mold lest air is caught in a connection of the mold and the supply port. If the mold is vertically placed to fill the mixture from the lower part of the mold, bubbles are preferably extruded upward. A method for stopping the supply of a mixture after being stabilized because of extruding bubbles once entered at the time of injection by providing the amount of the mixture greater than the amount required for filling in the mold is also effective. It is useful to employ an extra mixture to prevent disadvantages caused by bubbles due to small impact on the yield at the stage of materials while the yield become lower due to defects found after being a product.

Now, an explanation will be given to the second method showing some embodiments.

For example, a mixture 2 is fully applied onto the inner walls of a mold 1 to be an outer mold as shown in FIG. 1-1. An inner mold 3 is inserted as shown in FIG. 1-2 to fill a tubular space with a mixture. At this time, the extra mixture squeezes out from the mold. The extra mixture can be removed in an appropriate stage of the process. The outer mold may be in a container shape 4 as shown in FIG. 2-1 as another example. In this case, it is not necessary for the mixture 2 to be applied onto the inner walls of the mold 1 which is to be an outer mold, but the tubular space is automatically filled with resin as shown in FIG. 2-2 by the insertion of the inner mold 3 on the bottom of the container, if the mix solution remains on the bottom of the container.

Metals, glasses, ceramics, and resins and the like may be appropriately used as material for a mold of polyimide molding. To easily take out the formed polyimide molding, the surface of a mold may be coated with glass or fluorocarbon resin or may be preferably peeling treated, such as application of a mold lubricant and the like. It should be noted that polyamic acid is converted to polyimide by mixing a chemical curing agent, so that the permissible limits of solvent content of resin are reduced, which results in spontaneous exudation of the solvent so that the exudate is formed as a liquid film between the resin with self-supporting properties and the mold. Therefore, the method of the present invention has an advantage that conventional resources for mold releasing property are not always needed when using a mold as an intermediate curing mold only until polyamic acid develops self-supporting properties because this exudate liquid acts as a lubricant for easily taking out the semi-formed body with self-supporting properties. In the conventional method of application, even in the case of utilizing the above-mentioned mold as a final mold for heating and drying, peeling characteristics of resin after curing and prevention of repelling are antinomy in the conventional application method, so that restrictions have been added to the resin viscosity and surface condition of the mold to solve this problem, but in the present invention, there is no need for such restrictions.

The surface roughness (Ra) of the mold is 10 μm or smaller, preferably 5 μm or smaller, more preferably 1μm or smaller. If the surface roughness is 10μm or greater, there may be a possibility of mold releasing property of the resin tubular body being lowered by the adhesion and accumulation of the polyamic acid solution and inorganic powder on the surface after repeated use. However, when it is necessary to further coat the surface of the completed polyimide molding, a certain level of unevenness might be preferable to improve adhesion of the resin to be coated. In this case, to define the surface roughness to a certain level, physical surface treatment, such as polishing of the surface of the mold, may be selected as appropriate within a range in which the above-mentioned problem with the adhesion and accumulation is avoidable and high mold releasing property can be secured. In this case, the flexibility is higher because the above-mentioned advantageous function of lubrication also leads to prevent resin from being adhered compared with the case without chemical curing agent.

An explanation will now be given to the process after self-supporting properties of polyamic acid have developed by the effect of a chemical curing agent to form a polyamic acid (or polyimide wherein a partial polyamic acid portion remains) tubular body partially cured in the mold.

Two processes can be broadly taken hereafter. One is a method for forming a tubular polyimide by removing the cylindrical outer mold out of cylindrical outer and inner molds to adjust the shape of the tubular body and heating the tubular body together with the cylindrical inner mold. The other is a method for forming a tubular polyimide by re-locating the tubular body wherein self-supporting properties have developed into the other mold and heating the tubular body.

Next, characteristics of each method will be described in detail.

The first method is to use the inner mold as a mold for heating. In this case, it is possible to adjust the shape of the inner mold so that the inner mold may be easily treated in the next heating process. For example, the inner mold might be movable in a heating furnace using rod-like projections for handling formed on both ends of the inner mold. It is also possible to use a method for making the surface of the outer mold a composition and/or a form with smoother resin releasing property than that of the inner mold and a method for taking out the outer mold with the protruded part in conjunction with the inner mold held down by pouring the mixture in a state of extra protrusion from the mold to be semi-cured. The method for using an inner mold as a mold for heating as it is can take a continuous process without re-locating a semi-formed body, which results in further superior productivity.

The second method is used for heating a tubular body wherein self-supporting properties have developed after inserting the tubular body into the other mold. In this case, a method for taking out the semi-formed body with the development of self-supporting properties from the mold in the first place and then reinserting the semi-formed body into a mold for heating may be used or a method for removing only the inner mold out of the mutually movable cylindrical outer and inner molds and inserting the mold for heating instead of the inner mold and then removing the cylindrical outer mold may be used. At this time, as shown in FIG. 3, a method for inserting a mold for heating 5 simultaneously with taking out the inner mold 3 may be used. The method without taking out from the mold is more preferable because the semi-formed body is insusceptible to damages caused by operation errors.

The method for performing such a re-location, wherein restrictions on the surface of the mold for heating are more relaxed, leads to an advantage of aggressively modifying the mold for disengagement.

For example, there is an embodiment of using a ventilating porous medium having perforated holes to discharge air from the inside to the outside the mold (e.g. sintered metal and ceramics). Thus, the discharge of air after heating forms an air layer between the tubular polyimide and the mold, which enables the tubular polyimide to be more easily taken out from the mold. It is not preferable to use such a porous medium for a mold for developing the self-supporting properties by pouring the mixture due to intrusion of the mixture into the holes, even if a small quantity is undesirable. This kind of a process of transferring the mold is needed.

When compared to the method for using an inner mold for developing self-supporting properties as a mold for heating as it is, this method needs one extra process, but the productivity may eventually be higher depending on the composition of resin because of easy modification of the mold to be disengaged. It is possible to know when to use this method and when to use the other method in responsive to the difference in adhesion of resin to the mold and the like.

A grasp or hold part is required for the semi-formed body to take out the tubular semi-formed body wherein self-supporting properties have developed from a double tubular mold or to take out the outer mold only. Using the method for forming a semi-formed body, it is possible to provide the grasp or hold part by excessively injecting a resin into the mold and semi-curing in a state that the resin is protruded from the ends of the mold. The method for removing an end of the outer mold after semi-curing, assuming that at least one of the ends of the mold as a division-type mold is effective.

No matter whether it is a case of transferring or not, drying the solvent and imidization proceeds by heating after fitting the semi-formed body with self-supporting properties outside of the inner mold for heating (a state of without outer mold). Although the development of self-supporting properties means a considerable amount of decrease in the amount of solvent in the conventional method for developing self-supporting properties by heating (thermosetting method), in the method according to the present invention, the resin still contains a large amount of solvent in a state of development of self-supporting properties. When drying, it is possible to avoid destruction caused by forming phenomenon and thermal stress by sequentially increasing the heating temperature from the start of heating from the temperature not higher than the boiling point of the main solvent.

The system is cooled down after being heated up to the temperature required for the maintenance of strength to obtain a desired tubular polyimide. The temperature required for the maintenance of strength depends on a composition of polyimide, but approximately 350° C. to 550° C.

After cooling, the tubular polyimide is taken out from the mold. At this time, using a porous medium as a mold, the tubular polyimide is easily removable by discharging air from the inside toward the outside the porous medium. In addition, it is effective to mount a supersonic vibrator on the mold so that the adhesion may be removed by supersonic vibrations. Porous ceramics, porous metals, and porous carbons and the like may be employed as porous media. A porous medium may be also obtained by a method for boring fine holes on the plate-like metal as well as a perforated body, such as a mold for heating by punching and drilling and welding it in a cylindrical state. When its strength is insufficient after insertion of only a cylindrical body 6 made by working the plate-like metal, a method for fitting a mold 8 with holes 7 for air discharge in a rougher state into the further inside the cylindrical body 6 and the like may be used (See FIG. 4)

Laminating a layer containing other components onto the outer layer may be selected as appropriate in producing the above-mentioned polyimide molding. Examples of the outer layer include poly (tetra fluoroethylene), poly (vinylidene fluoride) and the like, but the layer is not limited to these examples.

As mentioned above, the embodiments of a method and an apparatus for producing a polyimide molding, particularly a method and an apparatus for producing a tubular body have been variously described so far, but the present invention is not limited to these embodiments. Also, any and all modifications, variations or equivalent arrangements which may occur to those skilled in the art should be considered to be within the scope of the invention.

### EXAMPLES

A method for producing a tubular polyimide according to the present invention will be now described in detail.

### Example 1

In a container with mixing blade, 24.60 Kg of dimethylformamide (DMF) was added to dissolve 2.57 Kg of 4,4′-diamino diphenylether under a nitrogen current. 2.81 Kg of pyromellitic acid dianhydride was gradually added to this while vigorously stirring. When the viscosity of the system reached approximately 380 Pa.sec, the addition of pyromellitic acid dianhydride was stopped. After stirring for 30 minutes, the stirring was stopped and a polyamic acid solution was obtained. The temperature was kept at about 20° C. during reaction while substituting the system under a nitrogen current. In the other container, 2.4 Kg of isoquinoline, 6.0 Kg of acetic anhydride, and 2.6 Kg of DMF were added to be vigorously stirred and a chemical curing solution was prepared. Each solution was fed to a multistage multi-bladed mixer from the respective tanks containing polyamic acid and chemical curing agent solutions at a 100:30 weight ratio using a gear pump through piping. A mixture was poured into a circular die provided on an end of the piping while stirring both of the solutions at about 200 rpm. The line reaching from each of the tanks through the piping and mixer to the circular die was cooled by making to flow a brine at −20° C. to the periphery.

Discharging the mixture from the circular die having a clearance of 500 μm, the polyamic acid solution was uniformly applied onto a SUS cylindrical coating mold with a length of 400 mm and an internal diameter of 82 mm while sliding the inside of the coating mold. The coating mold was previously heated at 60° C.

After a lapse of 3 minutes from the completion of application, the coated polyamic acid solution film obtained self-supporting properties. This semi-cured tubular material was easily removable from the SUS coating mold. The tubular material was inserted into a cylinder made of porous metal with an outer diameter of 80 mm (Hiporus produced by Kobe Steel, Ltd.) as shown in FIG. 4. An air inlet was provided on this cylinder to discharge air from inside toward outside. In addition, a fluorine-type peeling agent was previously sprayed on the perimeter surface. The residual solvent was evaporated at the same time when the semi-cured tubular material was completely imidized by heating the cylinder at 100° C. for 10 minutes, 200° C. for 5 minutes, 300° C. for 5 minutes, and 400° C. for 3 minutes. Subsequently, the mold was gradually cooled down to the room temperature and the tubular body was taken out by discharging air from the porous metal cylinder to obtain a tubular polyimide. This tubular polyimide has an average thickness of about 60 μm except 2 cm of both sides of the most end and each part had difference in thickness of 10 μm at the maximum.

### Comparative Example 1

An operation was performed in the same manner as in Example 1 without adding a chemical curing agent (It should be noted that dilution was performed using as equal amount of DMF as that of the chemical curing agent to unify the solid content concentration). Immediately after the application, a mold was charged into an oven having a temperature of 100° C. to obtain a self-supporting tubular body by drying. A glass mold was used because the self-supporting tubular body was not peeled off from the SUS coating mold.

The self-supporting tubular body taken out from the mold was fit over the porous metal mold in the same manner as in Example 1 and heated in the same manner. The completed tubular polyimide had a difference in thickness from 15 μm to 200 μm.

### Example 2

In a container with mixing blade, 8.20 Kg of dimethylformamide (DMF) was added to dissolve 862 g of 4,4′-diamino diphenylether under a nitrogen current. 938 g of pyromellitic acid dianhydride was gradually added to this while vigorously stirring. When the viscosity of the system reached approximately 300 Pa.sec, the addition of pyromellitic acid dianhydride was stopped and a polyamic acid solution was obtained. And then 1.05 Kg of FT-300 produced by Ishihara Sangyo Kaisha, Ltd. and 4.50 Kg of DMF were put into the other container to be vigorously stirred. A filler fluid dispersion was obtained by dispersing a metallic filler contained in the fluid dispersion after further dispersion with a supersonic disperser. The obtained fluid dispersion was dissolved in the above-mentioned polyamic acid solution to be vigorously stirred. After that, the container was defoamed under reduced pressure while continuing stirring.

In another container, 1.3 Kg of isoquinoline, 2.2 Kg of acetic anhydride, and 4.0 Kg of DMF were added to be vigorously stirred and a chemical curing solvent was prepared. Each solution was fed to a multistage multi-bladed mixer from the respective tanks containing polyamic acid and chemical curing agent solutions at a 100:10 weight ratio using a gear pump through piping from the lower part of each container while stirring both of the solutions at about 200 rpm.

On the other hand, a circular cylinder mold having a length of 400 mm and an outer diameter of 81 mm and a cylindrical mold having a length of 400 mm, an internal diameter of 82.4 mm, and an outer diameter of 92.4 mm were vertically placed so that the clearance might be uniform on the disc-like pedestal. The above-mentioned chemical curing agent mixture was poured from a resin inlet provided on the lower part of the outer mold and the pouring was stopped in a state of some extrusion from the upper part.

After a lapsed of 15 minutes under an environment temperature of 30° C., the coated polyamic acid solution film obtained self-supporting properties and the inner mold was taken out first. This inner mold was easily taken out without special modifications because the contact area of the inner mold and resin is smaller than that of the outer mold and resin. A cylinder made of porous metal with an outer diameter of 80 mm (Hiporus produced by Kobe Steel, Ltd.) was inserted into the space where the inner mold had existed as shown in FIG. 4. An air inlet was provided on this cylinder to discharge air from inside toward outside. In addition, a fluorine-type peeling agent was previously sprayed on the perimeter surface. The residual solvent was evaporated at the same time when the semi-cured tubular material was completely imidized by heating the semi-cured tubular body together with the cylinder at 100° C. for 10 minutes, 200° C. for 5 minutes, 300° C. for 5 minutes, and 400° C. for 3 minutes. Subsequently, the mold was gradually cooled down to the room temperature and the tubular body was taken out by discharging air from the porous metal cylinder to obtain a desired tubular polyimide.

### Example 3

In a container with mixing blade, 8.20 Kg of dimethylformamide (DMF) was added to dissolve 862 g of 4,4′-diamino diphenylether under a nitrogen current. 938 g of pyromellitic acid dianhydride was gradually added to this while vigorously stirring. When the viscosity of the system reached approximately 300 Pa.sec, the addition of pyromellitic acid dianhydride was stopped and a polyamic acid solution was obtained. And then 1.05 Kg of FT-300 produced by Ishihara Sangyo kaisha, Ltd. and 4.50 Kg of DMF were put into the other container to be vigorously stirred. A filler fluid dispersion was obtained by dispersing a metallic filler contained in the fluid dispersion after further dispersion with a supersonic disperser. The obtained fluid dispersion was dissolved in the above-mentioned polyamic acid solution to be vigorously stirred.

7.82 Kg of the above-mentioned resin mixture was taken and 0.13 Kg of isoquinoline was added to the mixture to be vigorously stirred. Defoaming was performed under a reduced pressure while continuing stirring. The obtained solution was referred to as solution B.

Similarly, 0.22 Kg of acetic anhydride was added to the above-mentioned 7.73-Kg resin mixture to be vigorously stirred and defoaming was performed. The obtained solution was referred to as Solution A.

Solutions A and B were measured by 200 g respectively and mixed with a static mixer (10 mmφ, the number of blades:24) to be poured into the clearance of the following mold.

The mold composed of a SUS circular cylinder mold (inner mold) having a length of 400 mm and an outer diameter of 81 mm and a SUS cylindrical mold (outer mold) having a length of 400 mm, an internal diameter of 82.4 mm, and an outer diameter of 92.4 mm were vertically placed so that the clearance might be uniform on the disc-like pedestal. Since the inner surface of the outer mold was still in a state of ordinary SUS finishing, fluoro-resin coating was performed on the outer surface of the inner mold to further improve mold releasing property.

The above-mentioned chemical curing agent mixture was poured from a resin inlet provided on the lower part of the outer mold and the pouring was stopped in a state of some extrusion from the upper part.

After a lapse of 7 minutes under an environment temperature of 30° C., the coated polyamic acid solution film obtained self-supporting properties and the inner mold was taken out first. A cylinder made of porous metal (hereinafter referred to as a mold for heating) with an outer diameter of 80 mm (Hiporus produced by Kobe Steel, Ltd.) was inserted into the space where the inner mold had existed as shown in FIG. 4. An air inlet was provided on this cylinder to discharge air from inside toward outside. In addition, a fluorine-type peeling agent was previously sprayed on the perimeter surface. Heating up to about 60° C. by a heater mounted on the periphery of the outer mold caused shrinkage of the semi-cured polyamic acid tubular body stronger than the adhesion strength to the inner surface of the outer mold. Due to this, the semi-cured polyamic acid tubular body was peeled from the outer mold and was closely adhered to the outer surface of the mold for heating. The residual solvent was evaporated at the same time when the semi-formed tubular body was completely imidized by heating the semi-cured polyamic acid tubular body together with the mold for heating at 100° C. for 10 minutes, 200° C. for 5 minutes, 300° C. for 5 minutes, and 400° C. for 3 minutes. Subsequently, the mold was gradually cooled down to the room temperature and the tubular body was easily removable by discharging air from the inside toward the outside of the mold for heating to obtain a desired tubular polyimide.

There have thus been shown and described a method and an apparatus for producing a polyimide molding which fulfill all the objects and advantages sought therefor. Many changes, modifications, variations, and other uses and applications of the subject invention will, however, become apparent to those skilled in the art after considering this specification and the accompanying drawings which disclose the preferred embodiments thereof. All such changes, modifications, variations, and other uses and applications which do not depart from the spirit and scope of the invention are deemed to be covered by the invention, which is to be limited only by the claims which follow.

What is claimed is:

1. A method of producing a polyimide molding, comprising the steps of:
preparing a solution containing polyamic acid as a main component;
providing the solution to a mold; and
drying the solution,
wherein, in the step of preparing the solution, a polyamic acid solution and a chemical curing agent are mixed.

2. A method of producing a polyimide molding, comprising the steps of:
mixing a solution containing polyamic acid as a main component and a chemical curing agent;
providing a mixture to a mold while it is still fluid;
after the polyamic acid contained in the mixture is changed into a semi-formed body which develops self-supporting properties, taking out the semi-formed body from the mold or removing a part of the mold; and
drying solvents which are present on the surface of and inside the semi-formed body by heating the semi-formed body to produce a polyimide molding.

3. The method of producing a polyimide molding according to claim 1 or 2, wherein said chemical curing agent comprises a dehydrating agent and a dehydrating catalyst.

4. The method of producing a polyimide molding according to claim 3, comprising at least the step of mixing:
Solution A: a solution that contains a dehydrating agent and that has polyamic acid as a main component; and
Solution B: a solution that contains a dehydrating catalyst and that has polyamic acid as a main component.

5. The method of producing a polyimide molding, comprising at least the steps of:
mixing following solutions A and B:
Solution A: a solution that contains a dehydrating agent and that has polyamic acid as a main component; and
Solution B: a solution that contains a dehydrating catalyst and that has polyamic acid as a main component;
pouring a mixture into a mold;
after the polyamic acid contained in the mixture is changed into a semi-formed body which develops self-supporting properties, taking out the semi-formed body from the mold or removing a part of the mold; and
drying solvents which are present on the surface of and inside the semi-formed body by heating the semi-formed body to produce a polyimide molding.

6. The method of producing a polyimide molding according to claim 4 or 5, wherein said solutions A and B are mixed by a static mixer.

7. The method of producing a polyimide molding according to claim 4 or 5, wherein liquid temperatures of said solutions A and B are 20° C. or less.

8. The method of producing a polyimide molding according to claim 3, wherein at least said dehydrating agent contains acetic anhydride and at least said dehydrating catalyst contains a tertiary amine compound.

9. The method of producing a polyimide molding according to claim 3, wherein a cold setting inhibitor is mixed in at least either one of the solution containing polyamic acid as a main component or the chemical curing agent.

10. The method of producing a polyimide molding according to claim 9, wherein said cold setting inhibitor is acetyl acetone.

11. The method of producing a polyimide molding according to claim 1 or 2, wherein the polyimide molding is shaped like a tube.

12. The method of producing a polyimide molding according to claim 1 or 2, wherein said mold is composed of a movable cylindrical inner and outer molds.

13. The method of producing a polyimide molding according to claim 12, comprising the steps of:
partially imidizing the polyamic acid by the chemical curing agent;
after the mixture becomes non-fluid, removing the inner mold from the semi-cured tubular body; and
after inserting a mold for heating into a space made by removing the inner mold, removing the outer mold.

14. The method of producing a polyimide molding according to claim 12, comprising the steps of:
partially imidizing the polyamic acid by the chemical curing agent;
after the mixture becomes non-fluid, removing the outer mold from the semi-cured tubular body; and
heating the semi-cured tubular body while the inner mold is used as a mold for heating to produce a tubular polyimide molding.

15. The method of producing a polyimide molding according to claim 12, wherein at least one end portion of said outer mold is separable; after the polyamic acid solution is partially imidized by the chemical curing agent and becomes non-fluid, only the end portion of the outer mold is removed; and taking out the semi-cured tubular body from the molds by holding or pushing the exposed portion of the semi-cured tubular body or removing only the outer mold.

16. An apparatus for producing a polyimide molding, comprising at least:
(i) a device for providing a solution containing polyamic acid as a main component;
(ii) a device for providing a chemical curing agent;
(iii) a mixing device for uniformly mixing the solutions provided from the devices (i) and (ii); and
(iv) a device for providing a mixture mixed in the device (iii) into a mold.

17. An apparatus for producing a polyimide molding, comprising at least:
(i) a device for providing a solution containing polyamic acid as a main component;
(ii) a device for providing a chemical curing agent;
(iii) a mixer for continuously mixing the solutions provided from the devices (i) and (ii); and
(iv) a device connected to the mixer (iii) for applying a mixture to a mold.

18. An apparatus for producing a polyimide molding, comprising:
a service tank for a solution A, said solution A containing a dehydrating agent and having polyamic acid as a main component;
a service tank for a solution B, said solution B containing a dehydrating catalyst and having polyamic acid as a main component;
a device for quantitatively removing the solutions A and B from the respective service tanks; and
a mixing device for preparing a mixture by mixing the solutions A and B removed from the respective service tanks.

19. The apparatus for producing a polyimide molding according to claim 18, wherein said mixing device is a static mixer.

20. The apparatus for producing a polyimide molding according to claim 18 or 19, further comprising a mold for containing the mixture and determining the shape of a resultant polyimide molding.

21. The apparatus for producing a polyimide molding according to claim 20, wherein the determined shape of a resultant polyimide molding is tubular.

22. The apparatus for producing a polyimide molding according to claim 21, wherein said mold is composed of a movable inner and outer molds.

23. An apparatus for producing a polyimide molding, comprising at least:
a device for providing a solution containing polyamic acid as a main component;
a device for providing a chemical curing agent;
a mixing device for mixing the solution provided from the device for providing a solution containing polyamic acid and the chemical curing agent provided from the device for providing a chemical curing agent;
a device for providing a mixture mixed in the mixing device into a mold;
a device for taking out a semi-cured body which develops self-supporting properties from the mold; and
a device for fitting the semi-cured body over a mold for heating.

24. An apparatus for producing a polyimide molding, comprising at least:
a device for providing a solution containing polyamic acid as a main component;
a device for providing a chemical curing agent;
a mixing device for mixing the solution provided from the device for providing a solution containing polyamic acid and the chemical curing agent provided from the device for providing a chemical curing agent;
a device for providing a mixture mixed in the mixing device into a mold pair, said mold pair composed of a movable cylindrical inner and outer molds;
a device for removing the inner mold and subsequently or simultaneously inserting a mold for heating; and
a device for removing the outer mold.

25. An apparatus for producing a polyimide molding, comprising at least:
a service tank for a solution A, said solution A containing a dehydrating agent and having polyamic acid as a main component;
a service tank for a solution B, said solution B containing a dehydrating catalyst and having polyamic acid as a main component;
a device for quantitatively removing the solutions A and B from the respective service tanks;
a mixing device for preparing a mixture by mixing the solutions A and B removed from the respective service tanks;
a device for providing the mixture prepared in the mixing device into a mold;
a device for taking out a pre-secured body that develops self-supporting properties from the mold; and
fitting the semi-cured body over a mold for heating.

26. An apparatus for producing a polyimide molding, comprising at least:
a service tank for a solution A, said solution A containing a dehydrating agent and having polyamic acid as a main component;
a service tank for a solution B, said solution B containing a dehydrating catalyst and having polyamic acid as a main component;
a device for quantitatively removing the solutions A and B from the respective service tanks;
a mixing device for preparing a mixture by mixing the solutions A and B removed from the respective service tanks;
a device for providing the mixture prepared in the mixing device into a mold pair, said mold pair composed of a movable cylindrical inner and outer molds;
a device for removing the inner mold and subsequently or simultaneously inserting a mold for heating; and
a device for removing the outer mold from the semi-cured body.

27. The apparatus for producing a polyimide molding according to any one of claims 22, 24, and 26, wherein said movable cylindrical inner and outer molds are separable at least at one end thereof.

28. The apparatus for producing a polyimide molding according to any one of claims 23 to 26, further comprising:
a device for heating the semi-formed body; and
a device for taking out a polyimide molding.
